(19) United States
(12) Patent Application Publication
(10) Pub. No.: US 2013/0301235 A1
(43) Pub. Date: Nov. 14, 2013

(54) Integrated Lighting Accessory and Case for a Tablet Computing Device

(71) Applicant: Hooshmand Harooni, Los Angeles, CA (US)

(72) Inventor: Hooshmand Harooni, Los Angeles, CA (US)

(21) Appl. No.: 13/470,311

(22) Filed: May 13, 2012

(51) Int. Cl. F21V 33/00; G03B 15/02

(52) U.S. Cl. 362/11; 362/109

(57) ABSTRACT

This invention describes a protective tablet computing device case that provides an LED lighting solution integrated within the case. The LED lighting solution can be utilized with the functions of the tablet computing device to provide additional illumination for photography and videography purposes as well as to provide ornamental or decorative enhancements to the tablet device.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### SUMMARY OF THE INVENTION

In view of the foregoing, the Integrated Lighting Accessory and Case for a Tablet Computing Device described in this application provides for a portable LED lighting solution integrated with a protective case to provide for illumination for a variety of different purposes as described below.
a. Photography and Videography Purposes: Some tablet computing devices provide for single or multiple LED lights built into the tablet computing device itself. The issue with many of these designs is that the illumination provided is not diffused sufficiently or not dispersed enough to be an appropriate lighting source for professional photography/videography purposes. Each individual LED light source in this invention can be covered by a frosted or softening lens, and this combined with the quantity of lights in the LED light ring delivers a significantly enhanced light source that is appropriate for this purpose.

One specifically unique example would be further for the utilization of the integrated Lighting Accessory and Case for a Tablet Computing Device as a light enhanced makeup mirror apparatus. Using the built-in camera of the tablet computing device to provide a videographic self-image in conjunction with the diffused but bright light source provided by the LED ring provides for an extremely clear and vivid image for the purpose of applying makeup. Further aiding in the application of makeup is the elimination of shadows that would otherwise be present from ambient light sources.
b. Ornamental or Decorative Purposes: Each LED light in the LED light ring can be individually turned on or off, or lit in sequence. The LED light ring can be provided in either a standard white light configuration or a tri-color configuration. In these different embodiments, the integrated Lighting Accessory and Case for a Tablet Computing Device invention can light up the LEDs for a variety of different applications. Some examples could be to light alternating LED lights in sequence or to light each LED light in the ring one at a time in rotating fashion to provide for different illuminating patterns either when desired by a user or associated with various running applications on the tablet computing device. Alternatively, in the configuration where tri-color LEDs are used, different color illuminations could also be utilized to represent different applications on the tablet computer, or to represent proximity of a task completion due date in an appointment scheduling application, and numerous other specific applications. In addition the case itself can be adapted to provide for different aesthetic designs around the LED lights themselves—a couple of different examples of this are show within the drawings to this application
c. Practical and/or Utilitarian purposes: The Integrated Lighting Accessory and Case for a Tablet Computing Device when provided with the optional built-in battery source can be used to supply power to both the LED light ring as well as to act as a secondary power source for the tablet computing device itself. In addition, the built in stand can provide for propping up the tablet computing device in either a horizontal or vertical orientation in an optimum viewing angle to the user.

This invention provides for a single piece protective case with several components. The bottom section of the Integrated Lighting Accessory and Case for a Tablet Computing Device contains an built in connector that can be attached to the docking connector port on the tablet computing device. This provides one anchor point to attach the tablet computing device to the protective case. Thereafter the tablet computing device can be snapped into the remainder of the protective case, which provides for a small flexible lip around the entire ring of the case that serves to lock the tablet computing device securely to the case.

The back of the protective case contains an integrated stand that can be flipped out and away from the back surface of the case to provide for and act as a stand for the mobile computing device. This integrated stand is attached to the protective case using a pliable and durable material that will allow for extensive use of moving the hinged stand inwards and outwards from the protective case in order to provide for unlimited uses without being impaired by service usage related to the number of times the hinged stand is moved back and forth. Finally, the back of the Integrated Lighting Accessory and Case for a Tablet Computing Device can optionally house a portable battery source mentioned earlier. This battery source would be a flat shaped battery source to confirm to the form and shape of the protective case.

The protective case unit also contains a thin circuit board attached to the LED light ring, (optional) power source (battery), and a connection to the docking port on the tablet computing device through the integrated connector in the inside surface of the case. This circuitry contains the processing power necessary to provide the control mechanism to address and control the illumination of each and every LED light contained within the LED light ring in the case.

The Integrated Lighting Accessory and Case for a Tablet Computing Device invention also will provide for an associated software application running on the mobile device that will allow third parties to control the LED lights on the ring. This application will be available as (a) an end user software application with an appropriate user interface that will allow users to create and associate differing light patterns with varying events on the tablet computing device, and (b) a software developer's toolkit that will allow third party software developers to write their own software applications that will allow them to, using the software toolkit, to control individual LED lights in the light ring in whatever manner they desire.

### BRIEF DESCRIPTION OF THE DRAWINGS

FIG. 1 A diagram showing side views of the protective case of the Integrated Lighting Accessory and Case for a Tablet Computing Device.

FIG. 2 Front view of the protective case of the Integrated Lighting Accessory and Case for a Tablet Computing Device without a tablet computing device attached.

FIG. 3 Front view of the protective case of the Integrated Lighting Accessory and Case for a Tablet Computing Device with a tablet computing device attached.

FIG. 4 Side views of the Integrated Lighting Accessory and Case for a Tablet Computing Device showing the tablet computing device being mounted.

FIG. 5 Detail of the integrated stand of the Integrated Lighting Accessory and Case for a Tablet Computing Device.

FIG. 6 Rear view of the Integrated Lighting Accessory and Case for a Tablet Computing Device

FIG. 7 Example of one aesthetic treatment of the LED light covers of the Integrated Lighting Accessory and Case for a Tablet Computing Device.

FIG. 8 A second example of an aesthetic treatment of the LED light covers of the Integrated Lighting Accessory and Case for a Tablet Computing Device

### DETAILED DESCRIPTION OF THE INVENTION

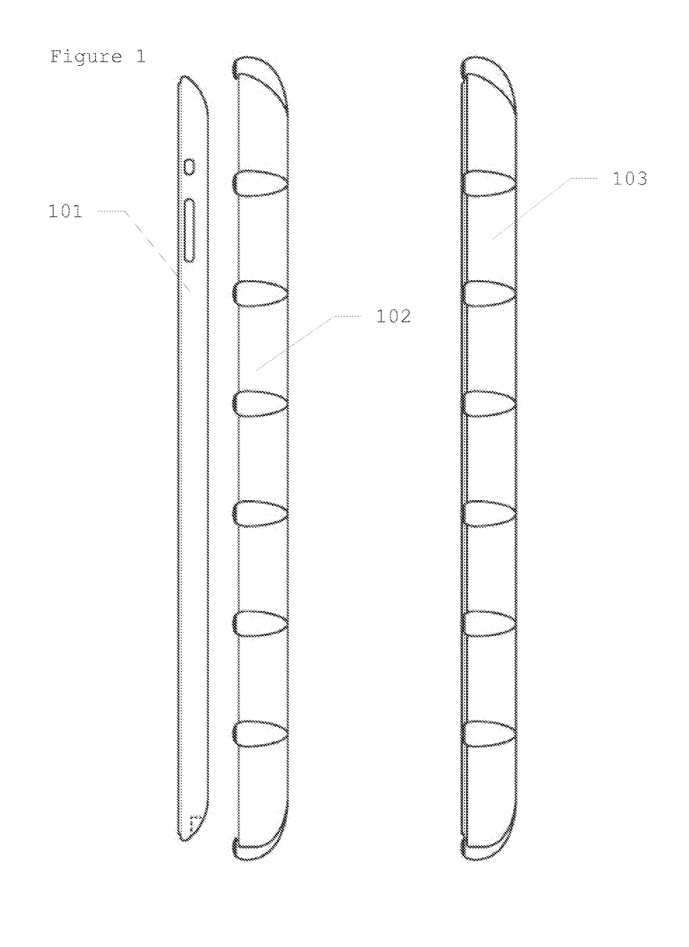

FIG. 1 in the attached diagrams shows a side view of the integrated Lighting Accessory and Case for a Tablet Computing Device. 102 and 103 depict the left and right side views of the protective case, respectively, and 101 shows an example of a tablet computing device (side view) about to be attached to the protective case.

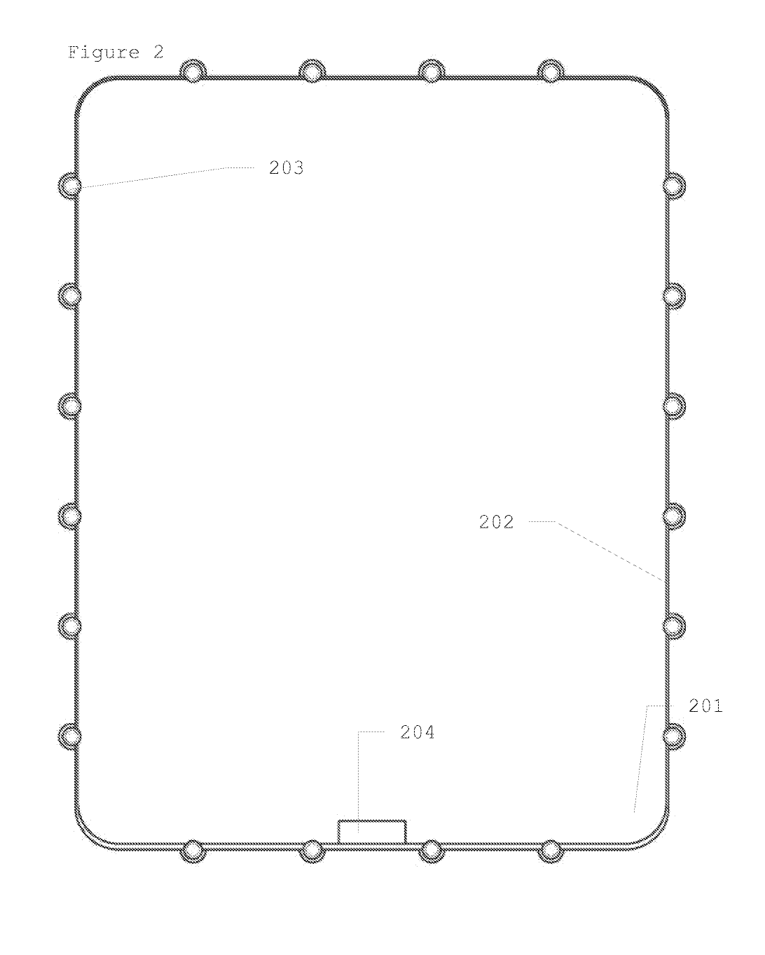

FIG. 2 shows a full on frontal view of the Integrated Lighting Accessory and Case for a Tablet Computing Device without a tablet computing device attached. 201 depicts the main body of the protective case, and the border frame 202 of the case provides for a small lip to help attach the tablet computing device to the case. 203 shows individual LED lights integrated into the protective case, and 204 shows an example of a built in connector component that can connect to the docking port of a tablet computing device when attached.

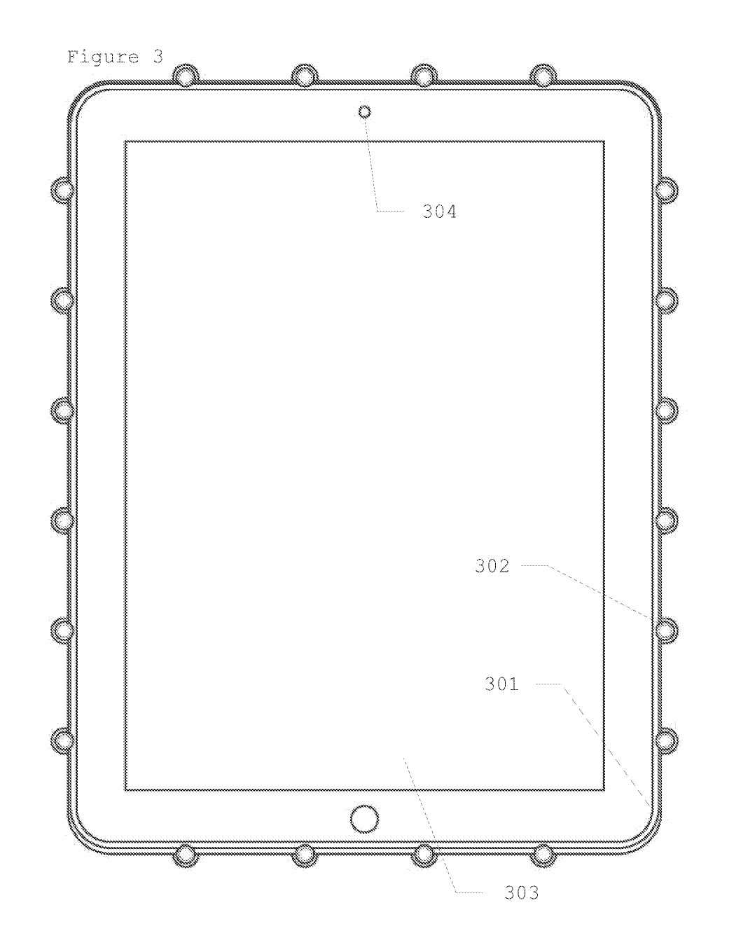

FIG. 3 shows a full on frontal view of the Integrated Lighting Accessory and Case for a Tablet Computing Device with a tablet computing device attached to the case. 301 depicts the frame of the protective case, 302 shows one of the many integrated LED light bulbs, and 303 shows the tablet computing device attached to and housed within the protective case. Optionally, 304 depicts an location for a camera that could be integrated within a tablet computing device.

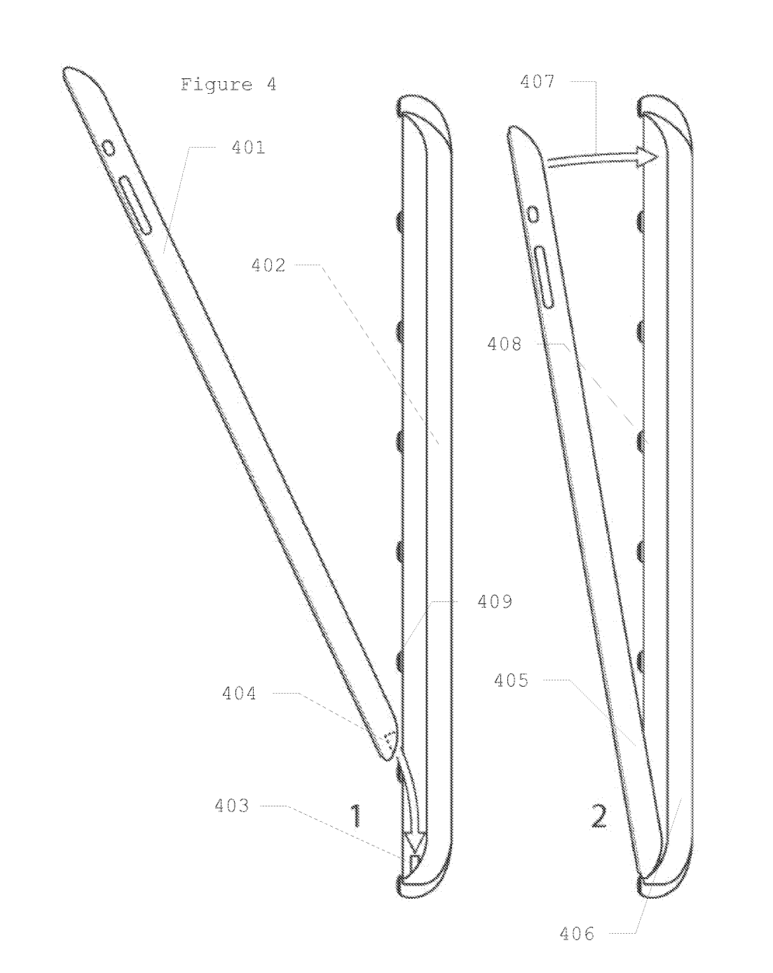

FIG. 4 shows side views of the Integrated Lighting Accessory and Case for a Tablet Computing Device with attachment points to mount the tablet computing device to the protective case. 401 shows a side view of a tablet computing device, and 402 shows a side view of the protective case. The bottom portion of the tablet computing device is attached through its docking port 404 to the connector 403 integrated into the protective case. This is step 1 of the attachment process. As step 2 of the attachment process, the tablet computing device 405 is tilted towards the protective case 406 in the direction of the arrow shown in 407. The protective lip around the frame of the case serves to secure the tablet computing device in place. 408 and 409 show LED light bulbs that are integrated into the protective case.

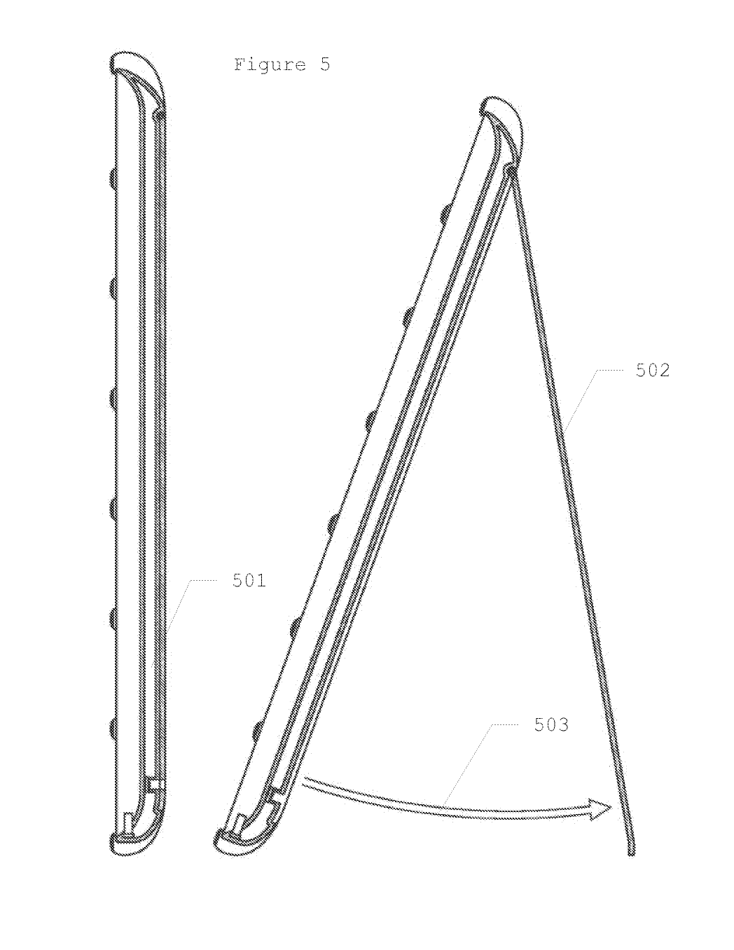

FIG. 5 depicts a side view of the “propped up tablet computer” function of the Integrated Lighting Accessory and Case for a Tablet Computing Device. 501 shows a side view of the tablet computing device attached to the protective case. The hinged stand 502 can be swung outwards from the protective case in the direction of the arrow shown in 503 to provide this functionality.

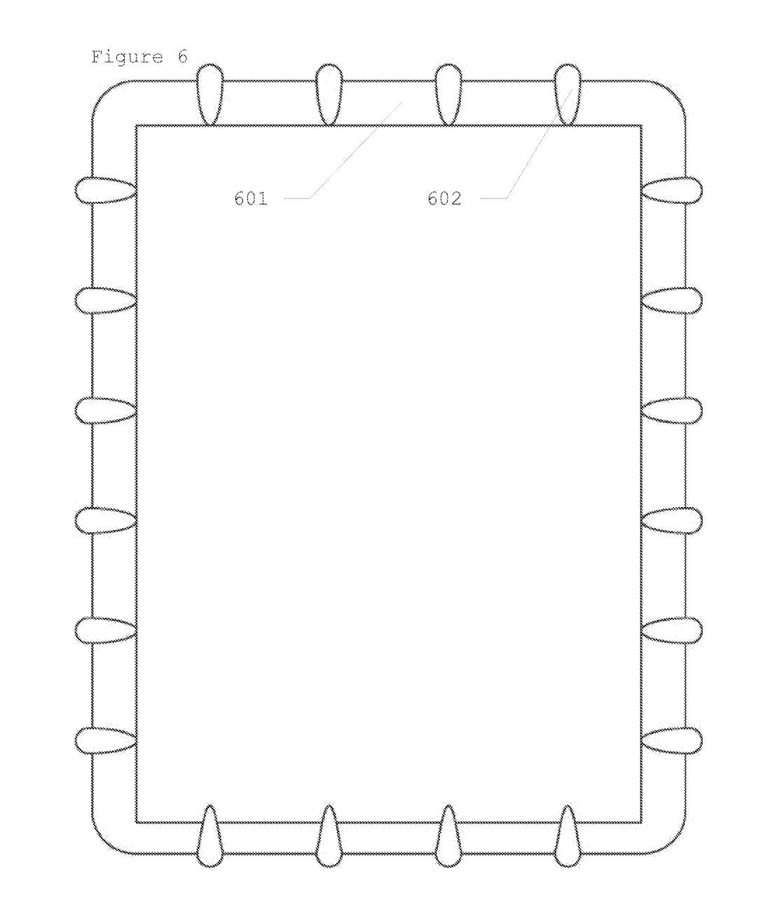

FIG. 6 shows the back view of the Integrated Lighting Accessory and Case for a Tablet Computing Device 601 shows the frame of the protective case, and 602 shows the back surface of the LED light elements in the case.

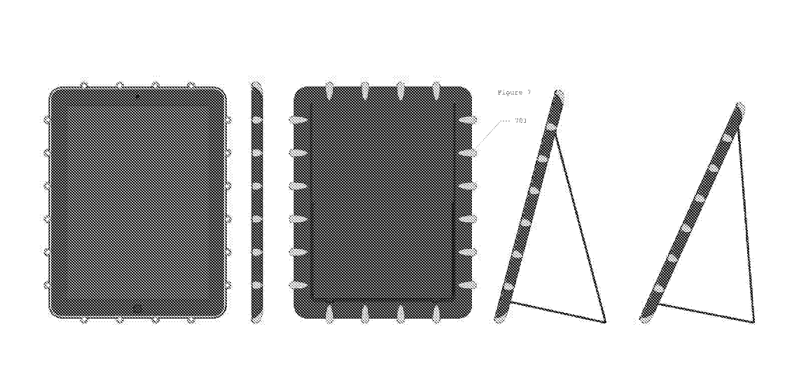

FIG. 7 shows one embodiment of an aesthetic treatment of the Integrated Lighting Accessory and Case for a Tablet Computing Device, with individual light treatment accents shown in 701.

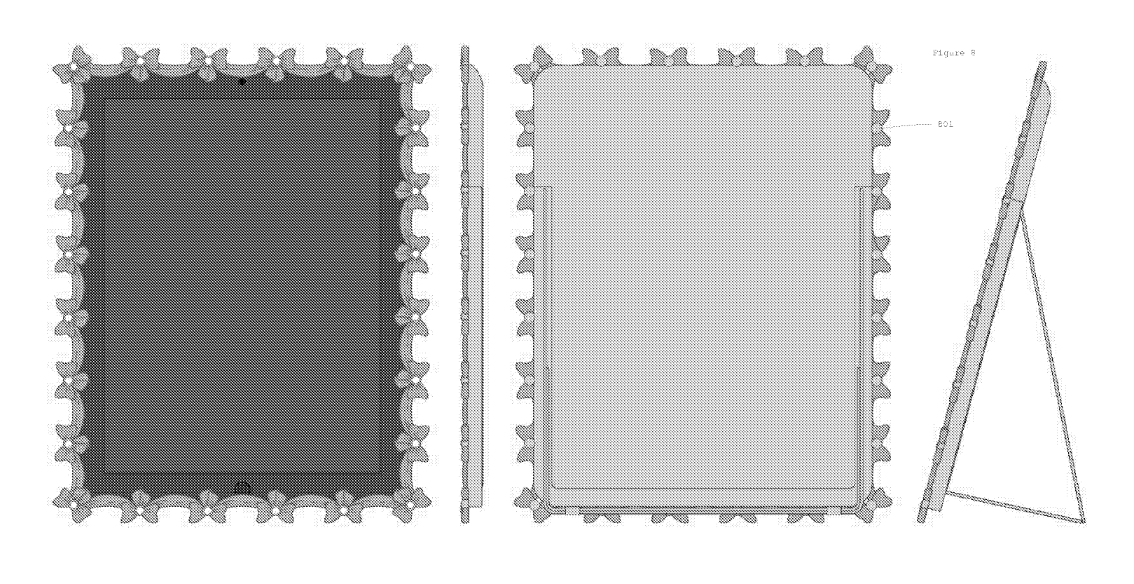

FIG. 8 shows a second embodiment of an aesthetic treatment of the Integrated Lighting Accessory and Case for a Tablet Computing Device, with individual light treatment accents shown in 801.

What is claimed is:

1: This invention (hereinafter known as “An integrated Lighting Accessory and Case for a Tablet Computing Device”) provides a protective tablet computing device case with an integrated ring of LED lights in the case to provide illumination to be used in conjunction with functionality native to the tablet computing device; wherein within the case there is embedded electronic circuitry that provides the ability to illuminate the LEDs simultaneously or selectively utilizing the tablet computing device's power supply drawn from a docking connector integrated to the protective case; wherein the ring of LED lights are mounted in a recessed manner in the case, with each LED light being covered by a lens to provide for diffusion of the illumination.

2: The Integrated Lighting Accessory and Case for a Tablet Computing Device described in claim 1, further utilized concurrently with the camera integrated into the tablet computing device such that the LED light ring can be illuminated to provide for a diffused light source to be used in conjunction with professional photography or videography purposes.

3: The Integrated Lighting Accessory and Case for a Tablet Computing Device described in claim 1 further providing for use with a software application executed on the device that provides the user with an ability to control the illumination properties of each individual LED on the protective case.
